(19) United States
(12) Patent Application Publication
(10) Pub. No.: US 2008/0213428 A1
(43) Pub. Date: Sep. 4, 2008

(54) Cream cheese-like food and process for production thereof

(76) Inventors: Ryotaro Sato, Tsukubamirai-shi (JP); Wataru Kugimiya, Izumisano-shi (JP)

Correspondence Address: WENDEROTH, LIND & PONACK, L.L.P., 2033 K STREET N. W., SUITE 800, WASHINGTON, DC, 20006-1021, US

(21) Appl. No.: 12/000,607

(22) Filed: Dec. 14, 2007

Related U.S. Application Data
(63) Continuation-in-part of application No. PCT/JP2006/312233, filed on Jun. 19, 2006.

(30) Foreign Application Priority Data
Jun. 17, 2005 (JP) 2005-178236

(51) Int. Cl. A23C 9/12; A23J 3/08

(52) U.S. Cl. 426/42; 426/656

(57) ABSTRACT

Disclosed is a cream cheese-like food which is produced by using a soybean protein as a raw material and which has a creamy-smooth mouthfeel like cream cheese and a good flavor/taste. A cream cheese-like food having a creamy-smooth mouthfeel and a good flavor/taste can be produced readily by previously adjusting the soybean protein material to a pH falling within the neutral to alkaline range before reducing the moisture content of a product by reacting the soybean protein with a protease to prepare a soybean protein hydrolysate.

### CROSS REFERENCE

This is a continuation-in-part application of PCT/JP2006/312233 now pending.

### TECHNICAL FIELD

The present invention relates to a cream cheese-like food and a process for production thereof.

### BACKGROUND ART

Cream cheese is generally produced by mixing sterilized milk with cream to prepare an emulsion, acid-coagulating the emulsion not by the action of a milk coagulating enzyme but by fermentation, and then removing whey. Cheese can be classified into a matured type which is matured after curdling and an unmatured type which is not subjected to a maturing step. Cream cheese is an unmatured-type cheese. Cream cheese has a fat content of about 33% and a protein content of about 9%.

In recent years, the demand for cream cheese has been greatly increased because of its soft mouthfeel and penetration of easy-to-eat individually-wrapped pieces of cream cheese. However, there are problems that people get tired of having cream cheese if they continue to eat it because it has a strong milk flavor, and that people who do not like dairy products and people who have an allergy to milk can not eat cream cheese. Therefore, a new type of cream cheese which does not contain milk components has been desired.

With the increased interest in health, vegetable protein foods have been appreciated. Particularly, soybean protein materials including soybean milk and an isolated soybean protein contain a good-quality soybean protein which is referred to as “meat from the field”, and therefore have been attracting attention as healthy foods.

To date, various attempts to produce a cream cheese-like food from a soybean protein material such as soybean milk have been made. However, the obtained cream cheese-like food had a higher fat content than that of normal cheese, and therefore a soybean protein had to be emulsified with an oil. For this purpose, an emulsifying agent or a gelling agent was generally used to impart emulsifying ability to a soybean protein and an oil (JP-A 59-6840, JP-A 59-146555, JP-A 60-78541).

However, even when emulsification was stabilized, the resulting food had a rough and sandy mouthfeel because the water retention capability of a soybean protein was higher than that of a milk protein which is the raw material for cheese. Thus, it was difficult to produce a cream cheese-like food having a creamy-smooth mouthfeel like cream cheese made from milk.

For improving the mouthfeel, a soybean protein may be hydrolyzed with a protease to reduce the water retention capability of the protein. However, when the water retention capability of a soybean protein is decreased, the ability to emulsify with an oil is also decreased, which causes an oil separation at the time of heat sterilization.

Thus, when a protease treatment was performed in production of a cream cheese-like food, it was necessary to use casein, an emulsifying agent or a gelling agent having higher emulsifying ability than that generally used in production of cream cheese (JP-A 57-159441, JP-A 60-87736, JP-A 60-251840). However, use of a large amount of casein dilutes the value of using a soybean protein as raw material, and use of an emulsifying agent or a gelling agent in a larger amount than usual deteriorates the flavor, taste and/or mouthfeel. For this reason, a cream cheese-like food having a creamy-smooth mouthfeel like cream cheese and a good flavor and taste has not been obtained using a soybean protein as a raw material.

### DISCLOSURE OF THE INVENTION

### Problem to be Solved by the Invention

An objective of the present invention is to provide a cream cheese-like food which is produced by using a soybean protein as a raw material and which has a creamy-smooth mouthfeel like cream cheese and a good flavor and taste.

### Means for Solving the Problem

In order to attain the objective, the present inventors intensively studied and, as a result, found that a cream cheese-like food having a creamy-smooth mouthfeel and a good flavor and taste could be readily produced by previously adjusting a soybean protein material such as commercially available soybean milk (about pH 6.6) to a pH falling within a neutral to alkaline range, before treating the soybean protein material with a protease to prepare a hydrolysate and thereby reducing the water retention capability of the protein, and then completed the present invention.

The present invention provides:

1. a cream cheese-like food produced by acidifying an emulsion containing a soybean protein hydrolysate obtained by a treatment with a protease in a neutral to alkaline range and an oil;

2. the cream cheese-like food according to the above 1, wherein the soybean protein hydrolysate is a hydrolysate of soybean milk;

3. the cream cheese-like food according to the above 1, wherein the soybean protein hydrolysate is a hydrolysate of an isolated soybean protein;

4. the cream cheese-like food according to the above 1, wherein the melting point of the whole oil contained in said food is 15 to 40° C.;

5. the cream cheese-like food according to the above 1, wherein the emulsion is acidified by lactic acid fermentation;

6. the cream cheese-like food according to the above 1, wherein the emulsion is acidified by acid addition;

7. the cream cheese-like food according to the above 1; wherein the acidified emulsion has pH 3.5 to 6;

8. a process for production of a cream cheese-like food which comprises the steps of:

(A) mixing a soybean protein material with an oil to prepare an emulsion;

(B) treating the soybean protein material with a protease in a neutral to alkaline range; and

(C) acidifying the emulsion to obtain an acidified emulsion;

9. the process for production of a cream cheese-like food according to the above 8, wherein a neutral to alkaline protease is used as the protease; and

10. the process for production of a cream cheese-like food according to the above 8, which further comprises the step of removing a whey component from the acidified emulsion to recover curd.

### EFFECTS OF THE INVENTION

According to the present invention, a cream cheese-like food can be stably produced without requiring a milk protein, an emulsifying agent or a gelling agent, wherein oil separation is not induced by heat sterilization in the production process and said cream cheese-like food maintains a stable emulsified state. Additionally, the cream cheese-like food thus obtained has a creamy-smooth mouthfeel in spite of using a soybean protein as a raw material.

### BEST MODE FOR CARRYING OUT THE INVENTION

The cream cheese-like food of the present invention is produced by acidifying an emulsion of a soybean protein hydrolysate and an oil and characterized in that the soybean protein hydrolysate is obtained by a treatment with a protease in a neutral to alkaline range.

A soybean protein material for obtaining a soybean protein hydrolysate is not particularly limited, and examples thereof include soybean milk, an isolated soybean protein, a concentrated soybean protein, a fractionated soybean protein, soybean flour, defatted soybean flour, and intermediate products in production of them. The soybean protein material can be appropriately selected depending on the physical property, flavor and taste, and nutritive value of the objective product.

Particularly, from the viewpoint of flavor and taste, soybean milk or an isolated soybean protein is preferably used as the soybean protein material. When soybean milk is used, the soybean milk is not particularly limited and may be soybean milk obtained from soybeans or defatted soybeans by a known method. For example, the soybean milk can be obtained by grinding whole soybeans, soybean flour or defatted soybeans in a wet state after being soaked or not being soaked in water, subjecting the ground soybeans to solid-liquid separation such as filtration or centrifugation, and then removing bean curd refuse as an insoluble fraction and collecting a soluble fraction. Further, the soybean milk also includes the so-called soymilk in a slurry form in which bean curd refuse remains unremoved. In such a case, it is preferable that particles of the bean curd refuse contained in the soymilk in a slurry form are pulverized by a physical means such as homogenizer or a chemical means such as enzymatic degradation.

A milk protein material such as casein as another protein may be added to the soybean protein material to prepare a compound-type protein material. However, when the addition amount of a milk protein material is too large, the characteristic of a cream cheese-like food produced using a soybean protein material is reduced. Further, when a large amount of a milk protein material is compound in a protein material, oil separation hardly occurs and therefore, it is difficult to realize the effect of the present invention. Therefore, the mixing weight ratio of a soybean protein material and a milk protein material is preferably 70:30, more preferably 90:10, further more preferably 100:0.

When the soybean protein material is subjected to enzymatic degradation, it is preferable that water is added to the soybean protein material to prepare a soybean protein solution with a crude protein content of about 2 to 20% by weight in the case of using a powdered isolated soybean protein or the like, and however, it is not necessary in the case of using soybean milk.

The soybean protein solution may be directly subjected to enzymatic degradation, or may be previously sterilized by heat. The sterilization temperature is not particularly limited. For example, the sterilization can be carried out at 60 to 155° C. for 1 second to 30 minutes. Although a sterilizer used is not particularly limited, UHT sterilization is preferable. A steam blowing-type heater that is a direct heater or a plate-type heater that is an indirect heater can be used. From the viewpoint of flavor and taste, a steam blowing-type direct heater is preferably used.

In the present invention, only a soybean protein material may be previously treated with a proteolytic enzyme (protease), or an emulsion of a soybean protein material with an oil may be prepared and then treated with a proteolytic enzyme (protease). It is important that the treatment with the enzyme is performed in a neutral to alkaline range.

Herein, “the treatment with the enzyme is performed in a neutral to alkaline range” means not only that the enzyme is reacted while such a range is maintained, but also that the enzyme is reacted in such a range and then in an acidic range.

That is, it is important that a soybean protein solution is previously adjusted to a pH falling within a neutral to alkaline range at least before the addition of a protease. It is not necessary to maintain the pH of a soybean protein solution within such a range during the enzyme reaction, and the pH may become acidic lower than 7.0 during the enzyme reaction.

The timing of adjusting the pH of a soybean protein solution is not particularly limited, and the pH may be adjusted at any step during or after production of the soybean protein material. The kind of alkali used for the pH adjustment is not particularly limited, and examples thereof include strong alkalis such as sodium hydroxide, potassium hydroxide and the like, and weak alkalis such as sodium carbonate, potassium carbonate and the like. In the case of using soybean milk as a soybean protein material, soybeans can be soaked in water to which a weak alkali such as sodium carbonate is added in advance to omit a pH adjustment step after production of soybean milk, and the soybean milk thus obtained can be directly subjected to a reaction with the enzyme.

The timing of treating a soybean protein material with a protease is not particularly limited as long as the pH of the soybean protein solution is adjusted to a neutral to alkaline range, and the treatment may be performed at any step during or after production of the soybean protein material. For example, in the case of using soybean milk, the treatment with a protease may be performed after soaking of soybeans or grinding of the soaked soybeans. In the case of using an isolated soybean protein, soybean milk is extracted from defatted soybeans and then subjected to acid precipitation to obtain curd, the curd is neutralized with an alkali and then adjusted to a neutral to alkaline range to obtain slurry, and the slurry can be treated with a protease.

It is essential that the pH of a soybean protein solution is in a neutral to alkaline range at the start of the enzyme reaction, and the pH is preferably pH 7.0 to 8.5, more preferably higher than pH 7.0 and not higher than pH 8.0, further preferably higher than pH 7.0 and not higher than pH 7.5.

It is also possible to adjust the pH of a soybean protein solution to an alkaline range higher than pH 8.5. In such a case, however, a large amount of an acid is required when an emulsion is acidified, and a longer fermentation time is required when an emulsion is fermented. Further, the obtained emulsion may have the so-called alkali odor in some cases.

On the other hand, when the hydrolysis of a soybean. protein solution is started at less than pH 7.0, protein aggregation easily occurs, thereby separation of an oil (oil off) is caused in the subsequent steps.

Although the pH of a soybean protein solution is gradually lowered during the enzyme reaction, the soybean protein solution is suitably maintained at pH 6.7 or higher, more preferably at pH 6.8 or higher after the enzyme reaction. When the soybean protein solution is at lower than pH 6.7 after the enzyme reaction, protein aggregation is increased and the emulsion stability is decreased, thereby separation of an oil (oil off) is caused in the subsequent steps. The addition amount and the reaction time of a protease may be appropriately determined so as to achieve the desired degradation rate.

The protease to be used for hydrolysis of a soybean protein includes an exoprotease and an endoprotease, and they can be used alone or in combination. The source of the protease is not particularly limited, and the protease may be derived from an animal, a plant or a microorganism. Since a reaction with the protease is performed at a pH falling within a neutral to alkaline range, the enzyme preferably has an activity at least in such a range, and more preferably, a neutral-alkaline protease is used. Examples of a commercially available protease that can be used in the present invention include thiol proteases (plant-derived papain, ficin, bromelain, and the like), serine proteases (animal-derived trypsin, chymotrypsin, microbially-derived subtilisin, carboxypeptidase, and the like), and the like. More specifically, examples of the plant-derived enzyme include “Papain W-40,” “bromelain F” (manufactured by Amano Enzyme Inc.), and the like. Examples of the enzyme containing endoprotease include “Alcalase” (manufactured by Novozymes Japan Ltd.) which is derived from Bacillus licheniformis, “Protin A” (manufactured by Daiwa Kasei K.K.) which is derived from Bacillus subtilis, “Protease S” and “Proleather FG-F” (manufactured by Amano Enzyme Inc.), “Bioprase SP-15FG” (manufactured by Nagase ChemteX Corporation.), “Protin AC-10” (manufactured by Daiwa Kasei K.K.), and the like. Examples of the enzyme containing exoprotease include “Umamizyme” (manufactured by Amano Enzyme Inc.) which is derived from Aspergillus, and the like. Examples of the proteolytic enzyme containing exoprotease and endoprotease include “Protease M” and “Protease A” (manufactured by Amano Enzyme Inc.) which are derived from Aspergillus oryzae, and the like.

The above-mentioned enzymes include enzymes having coagulation activity on protein which have been used as a milk coagulating enzyme in an acidic range for the conventional cheese production. In the case of using such an enzyme in the present invention, it is characterized in that a degradation reaction with the enzyme is carried out in such a pH range that soybean proteins do not aggregate and thereby the enzyme is not permitted to serve as a milk coagulating enzyme.

In the present invention, the soybean protein hydrolysate is suitably a partial hydrolysate having a soybean protein degradation rate of 5 to 35%, preferably 10 to 40%, more preferably 10 to 25%, as represented by solubility in 0.22 M trichloroacetic acid (TCA). When the TCA solubility is too low, it is difficult to obtain a cream cheese-like food having a creamy-smooth mouthfeel like cream cheese made from milk. When the TCA solubility is too high, the emulsion stability of an emulsion is decreased.

The reaction time of the enzyme for such partial. hydrolysis varies depending on the activity and amount of a protease to be used, and it may be appropriately adjusted. Suitably, it is usually about 5 minutes to 1 hour, preferably about 15 to 30 minutes.

The enzyme reaction is stopped by inactivating the enzyme by a heat treatment. The enzyme can be inactivated usually at 70 to 160° C. for 30 minutes to several seconds depending on the thermostability of the enzyme used. It is efficient that a heat treatment is performed for the purposes of both inactivation of the enzyme and thermal sterilization of an acidified emulsion in a later step.

The cream cheese-like food of the present invention is characterized in that it is produced by acidifying an emulsion containing the above-described soybean protein hydrolysate and an oil. The emulsion may be an emulsion prepared by emulsifying the above-described soybean protein hydrolysate with an oil, or an emulsion prepared by emulsifying a soybean protein material with an oil and then treating the resulting emulsion with a protease.

An oil that can be used for preparation of the emulsion is one or more selected from the group consisting of animal and plant oils, and processed oils prepared from them such as hardened oils, fractionated oils, ester-exchanged oils, diglycerides, and medium chain fatty acid containing oils. Examples of animal and plant oils include soybean oil, rapeseed oil, rice bran oil, sunflower oil, safflower oil, palm oil, palm kernel oil, coconut oil, corn oil, cottonseed oil, peanut oil, sal butter, shea butter, beef tallow, milk fat, lard, cacao butter, fish oil, whale oil, mustard oil, and the like. Among them, use of plant oils is preferable. Particularly, from the viewpoint of giving a good mouthfeel having easy meltability in the mouth, palm fractionated oil, rapeseed hardened oil and the like are preferable. The melting point of an oil may be appropriately selected in consideration of the hardness of a final product, and it is preferably 15 to 40° C., more preferably 20 to 37° C.

The amount of the oil added to the cream cheese-like food of the present invention is not particularly limited. The oil is suitably added to the food so that the content of the oil in the food becomes 5 to 35% by weight, preferably 10 to 30% by weight. When the oil content is too high, the obtained food has an oily flavor and taste. When the oil content is less than 5%, the obtained food has no rich flavor and taste.

For preparing the emulsion, a known homogenization means such as a homogenizer can be used. Since a homogenization pressure in the preparation of the emulsion influences the hardness of the texture of the obtained cream cheese-like-food, a person skilled in the art may appropriately select the pressure depending on the desired quality. Generally, the homogenization pressure is suitably 2.5 to 15 MPa (25 to 150 kg/cm²).

The emulsion thus obtained is acidified. In other words, the emulsion is adjusted to an acidic pH. Examples of an acidification means that can be used in the present invention include an addition of an acid, fermentation with lactic acid bacteria, and a combination of them.

When an acid is added to lower the pH of the emulsion, the emulsion may be used directly or after concentration. When fermentation with lactic acid bacteria is used to lower the pH of the emulsion, the emulsion preferably is subjected to a sterilization step in advance. Such sterilization is performed using a conventional pasteurizer which is not particularly limited. The sterilization conditions are also not particularly limited, and the sterilization is usually carried out at 80 to 160° C. for about 3 seconds to 15 minutes.

Any kind of acid which is not particularly limited can be used for the pH adjustment, and examples thereof include inorganic acids such as phosphoric acid, hydrochloric acid, sulfuric acid and the like, and organic acids such as citric acid, malic acid, lactic acid, gluconic acid, GDL and the like. These acids may be used alone, or two or more of them may be used in combination. From the viewpoint of flavor and taste, an organic acid is preferably used.

When the pH is lowered by lactic acid fermentation, a lactic acid bacterium usually used for production of yogurt or cheese can be used, and it is not particularly limited. Examples of a lactic acid bacterium that can be used include known strains, for example, the genus Lactobacillus including Lactobacillus bulgaricus, Lactobacillus helveticus, and Lactobacillus lactis subsp. cremoris; the genus Lactococcus including Lactococcus lactis subsp. lactis, Lactococcus lactis subsp. diacetylactis, and Lactococcus lactis subsp. lactis biovar diacetylactis; the genus Streptococcus including Streptococcus thermophilus; the genus Leuconostoc including Leuconostoc mesenteorides subsp. cremoris, and Leuconostoc pseudomesenteorides; and the genus Bifidobacterium including Bifidobacterium bifidum, Bifidobacterium longum, and Bifidobacterium breve; and the like. These lactic acid bacteria can be used alone, or two or more of these can be used in combination.

The fermentation can be started by adding a bulk starter which is prepared from a frozen-concentrated bacterium or a freeze-dried concentrated bacterium to the emulsion, or adding a frozen-concentrated bacterium or a freeze-dried concentrated bacterium directly to the emulsion. The addition amount of the bacterium can be adjusted depending on the fermentation temperature and the fermentation time. Suitably, the temperature of the lactic acid fermentation is between 20 and 50° C. for 3 to 48 hours, preferably between 20 and 45° C. for 4 to 30 hours.

When the fermentation is performed, it is preferable that saccharides which can be assimilated by lactic acid bacteria, such as glucose, maltose and lactose are previously added to the emulsion. The addition amount of the saccharides may be an amount sufficient to produce lactic acid depending on the species of a lactic acid bacterium used, and usually it is suitably about 0.2 to 5% by weight of the emulsion.

The acidic pH to which the emulsion is adjusted may be appropriately determined depending on the desired taste, and generally, it is suitably about pH 3.5 to 6, preferably pH 3.5 to 5.5, more preferably pH 4 to 5.5, further more preferably pH 4.5 to 5.5. When the pH is too low, the obtained cream cheese-like food has a too strong acid taste. When the pH is too high, the flavor and taste of fermentation are decreased in the case of using fermentation, and furthermore, the recovery rate of curd is lowered in the case of removing whey in the production process of the cream cheese-like food.

Next, after adjusting the emulsion to a predetermined pH, whey can be separated to recover curd, if necessary. When whey is separated, a cream cheese-like food in the. form of a solid or semisolid having a high solid content can be produced. The separation of whey may be carried out by a conventionally known separation method. Although a centrifugal machine is preferably used, mechanical expression or the like may also be utilized. When whey is not separated, a cream cheese-like food in the form of a liquid or paste having a low solid content can be produced. A person skilled in the art can appropriately determine whether whey is separated or not, taking into consideration the physical property suitable for the intended use of the produced food.

Next, a salt such as sodium chloride or potassium chloride is added to the emulsion from which whey has not been separated or the curd obtained after removing whey, if necessary. Then, the emulsion or curd is subjected to sterilization by heat. The heating condition is not particularly limited. Suitably, the sterilization is performed at 70 to 85° C. for about 1 second to 15 minutes.

After sterilization by heat, homogenization is carried out if necessary, to obtain an acidified emulsion. The homogenization can be performed by using a known means such as a homogenizer. At this point, a homogenization pressure is suitably 1.0 to 15 MPa (10 to 150 kg/cm²). After homogenization, the resulting emulsion is cooled to about 4 to 10° C. to obtain a cream cheese-like food.

The cream cheese-like food of the present invention may further contain a flavor such as a cheese flavor or a milk flavor; a seasoning such as monosodium glutamate; various spices; a puree such as a fruit puree; a powder such as a fruit powder; a sweetener such as sucrose, glucose, sorbitol, aspartame or stevia; and the like for the purpose of giving a flavor and taste. For the purpose of adjusting a color tone, the cream cheese-like food of the present invention may further contain an oil-soluble colorant such as β-carotene or annatto color. Furthermore, the cream cheese-like food of the present invention may also contain an additive such as a thickening stabilizer such as starch or a water-soluble soybean polysaccharide, or various preservatives.

When the water content of the obtained cream cheese-like food is higher, the physical property of the food moves closer to a paste or liquid state. When the water content of the obtained cream cheese-like food is lower, the physical property of the food moves closer to a solid state. Therefore, the water content may be adjusted, depending on the desired physical property of the food.

In order to provide the emulsion stability, an emulsifying agent such as lecithin, a fatty acid ester, or an organic acid monoglyceride; or a gelling agent such as locust bean gum, guar gum, xanthan gum, gum arabic, agar, or gelatin may be used. However, it should be noted that too much use of such an additive spoils the flavor, taste and mouthfeel of the obtained food. The present invention has the advantage that a cream cheese-like food can be produced without using a large amount of such an additive. Therefore, if the emulsion stabilizer is used in the present invention, the used amount is suitably less than 0.5% by weight, more preferably less than 0.2% by weight, further more preferably less than 0.1% by weight, most preferably less than 0.05% by weight of the obtained cream cheese-like food.

The cream cheese-like food of the present invention can be eaten as it is. In addition, the cream cheese-like food of the present invention can be widely applied as a food material, for example, a substitute for a spread, a filling, dairy cream or sour cream; sauce such as cream sauce or curry sauce; or an ingredient of confectionery such as cheesecake, pudding or Bavarian cream.

Hereinafter, an analytical method used in the present invention will be described.

### (TCA Solubility)

A 1.0% by weight protein solution was prepared by dispersing the protein in water and then stirring the dispersion enough. The proportion of a 0.22 M trichloroacetic acid (TCA) soluble protein in the total protein contained in the solution was measured by a protein quantitative determination method such as the Kjeldahl method or the Lowry method.

### EXAMPLES

Hereinafter, the present invention will be specifically described with reference to Examples. However, the technical scope of the present invention is not limited to Examples. In Examples, unless otherwise indicated, “%” means “% by weight”.

### Example 1

Commercially available soybean milk which was mild acidic (1780 g, solid content: 9.0%, pH 6.6) was adjusted to pH 7.2 with sodium hydroxide. Then, a palm fractionated oil (200 g, melting point: 26° C.) and lactose (20 g) were added to the soybean milk, and emulsified at 60° C. for 15 minutes using a homomixer. Thereafter, a plant-derived thiol protease [Papain W-40] (0.16 g; manufactured by Amano Enzyme Inc.) was added to the emulsion, and the enzyme reaction was performed for 30 minutes. After the reaction mixture was heated at 90° C. for 1 minute to inactivate the enzyme, it was homogenized under a homogenization pressure of 10 MPa using a homogenizer to obtain an emulsion of a soybean protein (soybean milk) hydrolysate and an oil. This emulsion obtained after the enzyme reaction had a TCA solubility of 17.7% and pH 6.9.

A starter of lactic acid bacteria (containing Lactococcus lactis subsp. cremoris, Lactcoccus lactis subsp. lactis, Leuconostoc mesenteoides subsp. cremoris, and Lactococcus lactis subsp. diacetylactis) (0.16 g) was added to the emulsion (800 g), and the mixture was fermented at 30° C. The fermentation was carried out until the pH of the mixture became 5.0. The obtained coagulation was centrifuged at 12000 G for 30 minutes to separate whey, and curd was recovered. Sodium chloride (1.2 g) was added to the curd (250 g). The mixture was sterilized by heat at 75° C. for 15 seconds, and then cooled to obtain a cream cheese-like food. The obtained food had a hardness of 180 gf as measured with a rheometer (using a circular plunger with a diameter of 1 cm).

### Example 2

### Change in a Method for Adjusting the pH of Soybean Milk

Dehulled soybeans were immersed in 6 times the weight of the raw material soybeans of water (85° C.) which was adjusted to pH 9.0 with sodium carbonate, for 50 minutes. Then, the immersing water was removed. The soybeans were drained and then ground with 4 times the weight of the raw material soybeans of hot water (95° C.). After the ground soybeans were maintained at 80° C. for 30 minutes, bean curd refuse was separated therefrom using a screw decanter. Thereafter, the obtained liquid was subjected to a sterilization treatment at 145° C. for 4 seconds to obtain sterilized soybean milk. The obtained soybean milk had pH 7.1 and was weakly alkaline.

An emulsion was prepared from the resulting soybean milk in the same manner as in Example 1, and then reacted with the enzyme. The emulsion obtained after the enzyme reaction had a TCA solubility of 16.0% and pH 6.8. Then, a cream cheese-like food was obtained from the resulting emulsion in the same manner as in Example 1.

### Example 3

### Change of the pH of Soybean Milk

An emulsion was obtained in the same manner as in Example 1 except that the commercially available soybean milk used in Example 1 was adjusted to pH 8.0. The emulsion obtained after the enzyme reaction had a TCA solubility of 17.1% and pH 7.7. Then, a cream cheese-like food was obtained from the resulting emulsion in the same manner as in Example 1. The obtained food had the same flavor, taste and mouthfeel as those of the food obtained in Example 1.

### Example 4

### Change of the Amount of an Oil

An emulsion was obtained in the same manner as in Example 1 except that the addition amount of the palm fractionated oil (melting point: 26° C.) was changed from 200 g to 160 g and the addition amount of the enzyme was changed from 0.16 g to 0.22 g. The emulsion obtained after the enzyme reaction had a TCA solubility of 22.3% and pH 6.8. Then, a cream cheese-like food was obtained from the resulting emulsion in the same manner as in Example 1.

### Example 5

### Change in the Degree of Hydrolysis of Soybean Milk

An emulsion was prepared in the same manner as in Example 1 except that the addition amount of the enzyme was changed from 0.16 g to 0.1 g. The emulsion obtained after the enzyme reaction had a TCA solubility of 11.0% and pH 7.0. Then, a cream cheese-like food was obtained from the resulting emulsion in the same manner as in Example 1.

### Example 6

Change in the Degree of Hydrolysis of Soybean Milk An emulsion was prepared in the same manner as in Example 1 except that the addition amount of the enzyme was changed from 0.16 g to 0.44 g. The emulsion obtained after the enzyme reaction had a TCA solubility of 33.5% and pH 6.8.

### Example 7

### Change of the Kind of a Soybean Protein Material

An emulsion was prepared in the same manner as in Example 1 except that commercially available soybean flour slurry containing soybean milk and bean curd refuse (solid content: 10.0%, pH. 7.1) was used in place of the soybean milk and subjected to the enzyme reaction without adjusting the pH. The obtained emulsion had a TCA solubility of 16.0%. Then, a cream cheese-like food was obtained from the obtained emulsion in the same manner as in Example 1.

### Example 8

### Preparation of Unfermented Type

A cream cheese-like food was obtained in the same manner as in Example 1 except that the emulsion was adjusted to pH 5.0 by an addition of 50% lactic acid in place of lactic acid fermentation.

### Comparative Example 1

An emulsion prepared in the same manner as in Example 1 except that the commercially available soybean milk (solid content: 9.0%, pH 6.6) was subjected to the enzyme reaction without adjusting the pH. Then, in the same manner as in Example 1, lactic acid fermentation was performed to prepare a cream cheese-like food.

The flavor and taste of the cream cheese-like foods obtained in Examples 1 to 8 and Comparative Example 1 were evaluated. The quality of the foods was evaluated by confirming whether oil separation was observed or not when the curd was sterilized by heat. Results are shown in Table 1.

TABLE 1
Quality evaluation

| | | | | | | | | | Comparative |
|---|---|---|---|---|---|---|---|---|---|
| | Example 1 | Example 2 | Example 3 | Example 4 | Example 5 | Example 6 | Example 7 | Example 8 | Example 1 |
| Soybean | Soybean | Soybean | Soybean | Soybean | Soybean | Soybean | Soybean | Soybean | Soybean |
| protein | milk | milk | milk | milk | milk | milk | flour | milk | milk |
| | | | | | | | slurry | | |
| Amount of | 10% | 10% | 10% | 8.2% | 10% | 10% | 10% | 10% | 10% |
| oil | | | | | | | | | |
| pH | After | During | After | After | After | After | Not | After | Not |
| adjustment | preparation | preparation | preparation | preparation | preparation | preparation | adjusted | preparation | adjusted |
| method | of soybean | of soybean | of soybean | of soybean | of soybean | of soybean | | of soybean | |
| | milk | milk | milk | milk | milk | milk | | milk | |
| pH before | 7.2 | 7.1 | 8.0 | 7.2 | 7.2 | 7.2 | 7.1 | 7.2 | 6.6 |
| enzyme | | | | | | | | | |
| reaction | | | | | | | | | |
| pH after | 6.9 | 6.8 | 7.7 | 6.8 | 7.0 | 6.8 | 6.8 | 6.9 | 6.3 |
| enzyme | | | | | | | | | |
| reaction | | | | | | | | | |
| TCA | 17.7% | 16.0% | 17.1% | 22.3% | 11.0% | 33.5% | 16.0% | 17.4% | 19.4% |
| solubility | | | | | | | | | |
| Acidification | Fermentation | Fermentation | Fermentation | Fermentation | Fermentation | Fermentation | Fermentation | Acid | Fermentation |
| of emulsion | | | | | | | | addition | |
| Oil | Not | Not | Not | Not | Not | Not | Not | Not | Observed |
| separation | observed | observed | observed | observed | observed | observed | observed | observed | |
| Flavor, | ⊚~◯ | ⊚ | ◯ | ◯~Δ | ◯ | ◯~Δ | ◯ | ◯~Δ | X |
| taste and | | | Slightly | Slightly | Slightly | | | | |
| mouthfeel | | | alkaline | less rich | rough | | | | |
| | | | odor | taste | mouthfeel | | | | |

Evaluation of flavor, taste and mouthfeel: ⊚ Very good ◯ Good Δ Acceptable X Bad

In Examples 1 to 8, no oil separation was observed when the curd was sterilized by heat, and cream cheese-like foods having a creamy-smooth mouthfeel and a good flavor and taste were obtained. In Comparative Example 1, intense oil separation was observed and thus a cream cheese-like food having good quality could not be obtained. In the case of the method of Comparative Example 1, oil separation could be prevented by adding 5 g of a sucrose fatty acid ester as an emulsifier and however, the flavor and taste of the cream cheese-like food thus obtained were spoiled.

In other words, when the pH of a soybean protein material was adjusted to a neutral to alkaline range at the start of reaction with a protease, a cream cheese-like food having high emulsion stability in which oil separation was not caused by heat and having a good flavor and taste could be obtained without using an emulsifying agent or the like.

In Example 5, the TCA solubility was low, and therefore the obtained food had a slightly rough mouthfeel and was losing a creamy-smooth mouthfeel.

In Example 6, oil separation was not caused by heat. However, when the addition amount of the enzyme was further increased until the TCA solubility became 40%, emulsification was difficult, and the resulting food had a strong amino acid taste probably because the amount of free amino acid was increased.

### Example 9

### Use Example 1 of Isolated Soybean Protein

Water (820 g) was added to a mixture of an isolated soybean protein (50 g) and a palm fractionated oil (130 g, melting point: 26° C.), and then emulsified at 60° C. for 15 minutes using a homomixer. After emulsification, the emulsion was adjusted to pH 7.2 with sodium hydroxide, and then subjected to enzymatic degradation with a plant-derived thiol protease [Papain W-40] (manufactured by Amano Enzyme Inc.) (0.06 g) for 30 minutes. After the reaction mixture was heated at 90° C. for 1 minute to inactivate the enzyme, it was homogenized under a homogenization pressure of 10 MPa using a homogenizer to obtain an emulsion of a soybean protein hydrolysate and an oil. This emulsion obtained after the enzyme reaction had a TCA solubility of 15.5% and pH 6.9. The obtained emulsion (300 g) was subjected to the same procedure as in Example 1 to obtain a lactic acid fermentation-type cream cheese-like food. In addition, the above-described emulsion (300 g) was subjected to the same procedure as in Example 8 to obtain a unfermented-type cream cheese-like food.

### Example 10

### Use Example 2 of Isolated Soybean Protein

A protein was extracted with water from defatted soybeans (1,000 g) according to a conventional method. Bean curd refuse was removed from the extract to obtain defatted soybean milk. The defatted soybean milk was adjusted to pH 4.5 with hydrochloric acid to acid-precipitate the protein, and then centrifuged to remove whey and recover curd. Water was added to the curd to obtain a soybean protein solution having a solid content of 10% (3,800 g). The solution was adjusted to pH 7.6 with sodium hydroxide, and then subjected to enzymatic degradation with a plant-derived thiol protease [Papain W-40] (manufactured by Amano Enzyme Inc.) (0.38 g). The reaction mixture was heated at 145° C. for 5 seconds to inactivate the enzyme, and then spray-dried to obtain an isolated soybean protein partial hydrolysate. The isolated soybean protein partial hydrolysate had TCA solubility of 13.6%. A mixture of the isolated soybean protein partial hydrolysate (90 g), a palm fractionated oil (330 g, melting point: 26° C.) and water (580 g) was emulsified at 60° C. for 15 minutes using a homomixer. Thereafter, the emulsion was adjusted to pH 5.0 by an addition of 50% lactic acid, and then 50 g of sodium chloride was added thereto. The mixture was homogenized under 10 MPa using a homogenizer, sterilized by heat at 75° C. for 15 seconds, and then cooled to obtain a cream cheese-like food.

### Application Example 1

### Use as a Spread

A slice of bread was cut in half. The cream cheese-like food obtained in Example 1 was spread on one side of each half. Then, a mixture of sliced potatoes, whole corns and tuna flakes as a filling was sandwiched between the spread sides of the halves. The sandwich was baked to obtain a hot sandwich. The obtained hot sandwich was a hearty food because of the spread of the cream cheese-like food, and had a good mouthfeel because the spread of the cream cheese-like food prevented the moisture of the filling from moving into the bread.

### Application Example 2

### Use as a Japanese Style Sauce (Sticky Sauce)

Garlic, ginger and comminuted meat were fried in a frying pan in which sesame oil was previously put and warmed. Aroids were cut to the proper size and added into. the pan. Subsequently, soup stock, soy sauce, mirin (Japanese sweet rice wine for cooking), sake and sesame oil were added to the ingredients in the pan, and simmered for a short time. Then, the whole cooked food was dressed with the cream cheese-like food obtained in Example 1, and thereby thickness was provided. The cream cheese-like food on the cooked food had a natural physical property like the thickness provided by starch, and therefore, was a good Japanese style sauce. Such a Japanese style sauce can not be provided by using cream cheese made from milk.

### Application Example 3

Application to Cheesecake made using Soybean Milk

The cream cheese-like food obtained in Example 1 (250 g) was melted until it became creamy. Yolks obtained from two eggs and lemon juice obtained from a half lemon were added to the cream cheese-like food and then mixed well. The mixture was mixed with dairy cream (100 cc) and wheat flour (30 g), and then with meringue. After shape forming, the mixture was baked to obtain a soybean milk cheesecake. The soybean milk cheesecake did not have a heavy taste like a conventional cheesecake, and had a light and good taste.

1. A cream cheese-like food produced by acidifying an emulsion containing a soybean protein hydrolysate obtained by a treatment with a protease in a neutral to alkaline range and an oil.

2. The cream cheese-like food according to claim 1, wherein the soybean protein hydrolysate is a hydrolysate of soybean milk.

3. The cream cheese-like food according to claim 1, wherein the soybean protein hydrolysate is a hydrolysate of an isolated soybean protein.

4. The cream cheese-like food according to claim 1, wherein the melting point of the whole oil contained in said food is 15 to 40° C.

5. The cream cheese-like food according to claim 1, wherein the emulsion is acidified by lactic acid fermentation.

6. The cream cheese-like food according to claim 1, wherein the emulsion is acidified by acid addition.

7. The cream cheese-like food according to claim 1, wherein the acidified emulsion has pH 3.5 to 6.

8. A process for production of a cream cheese-like food which comprises the steps of:
(A) mixing a soybean protein material with an oil to prepare an emulsion;
(B) treating the soybean protein material with a protease in a neutral to alkaline range; and
(C) acidifying the emulsion to obtain an acidified emulsion.

9. The process for production of a cream cheese-like food according to claim 8, wherein a neutral to alkaline protease is used as the protease.

10. The process for production of a cream cheese-like food according to claim 8, which further comprises the step of removing a whey component from the acidified emulsion to recover curd.
